(19) United States
(12) Patent Application Publication
(10) Pub. No.: US 2025/0019315 A1
(43) Pub. Date: Jan. 16, 2025

(54) Quartz stone patterned full-body plate and its preparation method

(71) Applicant: ZHAOQING WEITAI QUARTZ STONE CO., LTD, Zhaoqing, Guangdong (CN)

(72) Inventors: Weijun Zhu, Zhaoqing, Guangdong (CN); Lianhua SU, Zhaoqing, Guangdong (CN); Roberto CAVALIERE, Zhaoqing, Guangdong (CN)

(21) Appl. No.: 18/037,769

(22) PCT Filed: Apr. 7, 2022
(86) PCT No.: PCT/CN2022/085614

§ 371 Date: May 19, 2023

(51) Int. Cl. C04B 41/45; B28B 1/08; B28B 11/00; C04B 24/42; C04B 30/00; C04B 40/00; C04B 41/48; C04B 41/63

(52) U.S. Cl. CPC C04B 41/4576; B28B 1/082; B28B 11/001; C04B 24/42; C04B 30/00; C04B 40/0067; C04B 40/0082; C04B 40/0089; C04B 41/48; C04B 41/63

(57) ABSTRACT

A preparation method of a quartz stone patterned full-body plate includes seven steps of preparing a material, preparing a rough sheet, performing pattern treatment, preparing a pressing plate, baking, polishing and printing. Through matching the main materials with the pigment paste and color powders, especially each of the main materials is a mixture which includes at least three different ingredients, the preparation method improves the naturalness of the color and texture of the plate, making the plate closer to nature. Through matching different particle sizes of granular raw materials with silicon micro-powders in the mixture, the plate is able to obtain a uniform surface spherical effect. Through the cooperation of granular raw materials, silicon micro-powders, the pigment, the silane coupling agent, unsaturated polyester resin and the curing agent, the plate is able to obtain good earth resistant performance, abrasion resistance; is not easy to deform, crack, fade and tarnish; and has good decorative effect.

### BACKGROUND OF THE PRESENT INVENTION

### Field of Invention

The present invention relates to the field of quartz stone preparation technology, and more particularly to a quartz stone patterned full-body plate and its preparation method.

### Description of Related Arts

The quartz stone plate is a kind of decorative material often used in the construction industry. The initial quartz stone is prepared from calcium carbonate as a filler, unsaturated resin and a curing agent. Subsequently, the quartz stone plate is prepared from polyformaldehyde methacrylate and aluminium hydroxide as raw materials. Microlite also appears and it is prepared by sintering a natural inorganic ore such as natural quartz stone and an aluminium oxide through roasting furnace, flux, water rate and crystallization cave treatment. In the latest preparation process, some people use natural quartz sand powders and new resins to prepare the quartz stone. After searching, it is found that the patent document CN 111574110 A discloses a preparation method of a quartz stone plate, in which an antique wood grain quartz stone plate is prepared by mixing particles in different specifications; the patent document CN 106810122 A discloses a preparation method of an anti-crack quartz stone plate, which focuses on the cracking resistance of the quartz stone plate. Through the analysis of the existing technology, it can be seen that the preparation process of the quartz stone plate is not systematic at present, and the comprehensive performance of the quartz stone plate is general.

### SUMMARY OF THE PRESENT INVENTION

In view of the shortcomings in the prior art, an object of the present invention is to provide a quartz stone patterned full-body plate and its preparation method. The preparation method is systematic and complete. The prepared quartz stone plate has good earthquake resistant performance and abrasion resistance. It is not easy to deform, crack, fade and tarnish, and has good decorative effect.

To achieve the above object, the present invention adopts technical solutions as follows.

A preparation method of a quartz stone patterned full-body plate comprises steps of preparing a material, preparing a rough sheet, performing pattern treatment, preparing a pressing plate, baking, polishing and printing.

Preferably, the preparation method specifically comprises steps of:
(1) preparing a material d, which comprises preparing a material a, a material b and a material c respectively by mixing three different amounts of main materials with a pigment respectively, and stirring evenly; and mixing the material a, the material b and the material c, so as to obtain the material d;
(2) preparing a rough sheet e, which comprises transporting the material d from a blending machine to a material distribution machine, laying the material d evenly in a rubber membrane frame which is located under the material distribution machine, vacuumizing, vibration-assisted compacting, drying, thickness-defining, and polishing, so as to obtain the rough sheet e;
(3) performing pattern treatment, wherein the pattern treatment is performed on the rough sheet e for three times by a robot rocker arm;
(4) preparing a pressing plate by vacuumizing and vibration-assisted compacting, wherein a frequency of vacuumizing and vibration-assisted compacting is in a range of 39-57 Hz;
(5) baking, which comprises baking the pressing plate obtained by the step (4) in a curing box;
(6) polishing, wherein a polishing head is used to improve a smoothness of a sheet material obtained by the step (5), so that a surface smoothness of the sheet material is higher; and
(7) printing, which comprises simulating patterns of the quartz stone plate to be prepared in advance, wherein the patterns of the quartz stone plate to be prepared are consistent with patterns of a trajectory of the robot rocker arm in the step (3), processing the simulated patterns at high temperature in a printing machine, and printing the simulated patterns after high-temperature treatment on a quartz stone patterned plate obtained by the step (6).

Preferably, a mass percentage of all of the three main materials in the material d is in a range of 97.5% to 99.85%, the rest is the pigment; a mass percentage of pigment paste and color powders of the pigment in the material d is in a range of 0.1%-1.5% and 0.05%-1% respectively.

Preferably, each of the three main materials comprises 17%-26% of quartz sand with a particle size in a range of 26-40 meshes, 34%-41% of quartz sand with a particle size in a range of 40-70 meshes, 27%-30% of silicon micro-powders with a particle size in a range of 600-800 meshes, 0.02%-2.3% of colorant, 0.01%-0.015% of silane coupling agent, 10%-12% of UPR (unsaturated polyester resin) and 0.01%-0.014% of curing agent by weight.

Preferably, a mass percentage of the material a, the material b and the material c in the material d is in a range of 50-60%, 25-35% and 5-15% respectively.

Preferably, the silane coupling agent is at least one member selected from a group consisting of KH550, KH560, KH570, KH792, DL602 and DL171; the curing agent is at least one member selected from a group consisting of tert-butyl peroxide, cyanamide, metaphenediamine and methylenediphenyldiamine.

Preferably, in the step (3), while performing the pattern treatment for a first time, the pigment paste comprises 100 G of resin, 0.03 G of lead chrome green and 0.018 G of Bayferrox black; in the step (3), while performing the pattern treatment for a second time, the pigment paste comprises 100 G of resin, 0.03 G of lead chrome green and 0.036 G of Bayferrox black; in the step (3), while performing the pattern treatment for a third time, the pigment paste comprises 100 G of resin, 0.05 G of Bayferrox black, 0.01 G of Bayferrox yellow and 1 G of titanium dioxide.

Preferably, in the step of (5), a baking temperature is in a range of 85° C. to 95° C., and a baking time is in a range of 40 min to 50 min.

Preferably, in the step of (5), the curing box comprises a box body and a plate layer, wherein the plate layer is provided within the box body and is made of aluminium alloy, the plate layer comprises seven upper plates and seven lower plates, the pressing plate is provided between the upper plates and the lower plates, a hot oil layer is provide within each of the upper and lower plates, an “S”-shaped hot oil pipe is provided within the hot oil layer, gasoline flows in the hot oil pipe to dry the pressing plate.

Also, the present invention provides a quartz stone patterned full-body plate which is prepared by the above preparation method.

Compared with the prior art, the present invention has some beneficial effects as follows.

(1) The preparation method of the quartz stone plate provided by the present invention is complete and systemic, which is suitable for actual production.

(2) Through matching the main materials with the pigment paste and color powders, especially each of the main materials is a mixture which includes at least three different ingredients, the preparation method of the quartz stone plate provided by the present invention improves the naturalness of the color and texture of the obtained plate, making the plate closer to nature. Through matching different particle sizes of granular raw materials with silicon micro-powders in the mixture, the plate is able to obtain a uniform surface spherical effect. Through the cooperation of granular raw materials, silicon micro-powders, the pigment, the silane coupling agent, UPR (unsaturated polyester resin) and the curing agent, the plate is able to obtain good earth resistant performance, abrasion resistance; is not easy to deform, crack, fade and tarnish; and has good decorative effect.

### BRIEF DESCRIPTION OF THE DRAWINGS

FIG. 1 is a schematic diagram of a quartz stone patterned full-body plate which is prepared by a method according to a first preferred embodiment of the present invention.

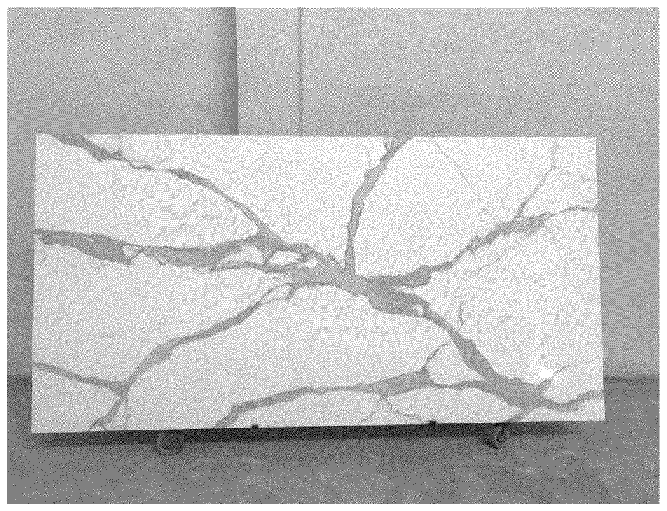

### DETAILED DESCRIPTION OF THE PREFERRED EMBODIMENT

In order to make the objectives, technical solutions and advantages of the present invention clearer, the present invention will be further described in detail as below with reference to embodiments.

A preparation method of a quartz stone patterned full-body plate comprises seven steps of preparing a material, preparing a rough sheet, performing pattern treatment, preparing a pressing plate, baking, polishing and printing.

Preferably, the preparation method specifically comprises steps of:
(1) preparing a material d, which comprises preparing a material a, a material b and a material c respectively by mixing three different amounts of main materials with a pigment respectively, and stirring evenly; and mixing the material a, the material b and the material c, so as to obtain the material d;
(2) preparing a rough sheet e, which comprises transporting the material d from a blending machine to a material distribution machine, laying the material d evenly in a rubber membrane frame which is located under the material distribution machine, vacuumizing, vibration-assisted compacting, drying, thickness-defining, and polishing, so as to obtain the rough sheet e;
(3) performing pattern treatment, wherein the pattern treatment is performed on the rough sheet e for three times by a robot rocker arm;
(4) preparing a pressing plate by vacuumizing and vibration-assisted compacting, wherein a frequency of vacuumizing and vibration-assisted compacting is in a range of 39-57 Hz;
(5) baking, which comprises baking the pressing plate obtained by the step (4) in a curing box;
(6) polishing, wherein a polishing head is used to improve a smoothness of a sheet material obtained by the step (5), so that a surface smoothness of the sheet material is higher; and
(7) printing, which comprises simulating patterns of the quartz stone plate to be prepared in advance, wherein the patterns of the quartz stone plate to be prepared are consistent with patterns of a trajectory of the robot rocker arm in the step (3), processing the simulated patterns at high temperature in a printing machine, and printing the simulated patterns after high-temperature treatment on a quartz stone patterned plate obtained by the step (6).

Preferably, a mass percentage of all of the three main materials in the material d is in a range of 97.5% to 99.85%, the rest is the pigment; a mass percentage of pigment paste and color powders of the pigment in the material d is in a range of 0.1%-1.5% and 0.05%-1% respectively. It is able to be understood that the mass percentage of all of the three main materials is 97.5%, 98%, 98.5%, 99%, 99.5%, 99.85% and any value in the range of 97.5% to 99.85%. Accordingly, the mass percentage of the pigment paste is 0.1%, 0.5%, 1.0%, 1.5% and any value in the range of 0.1% to 1.5%; the mass percentage of the color powders is 0.05%, 0.1%, 0.5%, 1% and any value in the range of 0.05% to 1%.

Preferably, the pigment paste or the color powders is at least one member selected from a group consisting of titanium dioxide, Bayferrox black, Bayferrox yellow and Bayferrox brown, and a specific collocation is subject to an actual demand of the quartz stone patterned full-body plate.

Preferably, each of the three main materials comprises 17%-26% of quartz sand with a particle size in a range of 26-40 meshes, 34%-41% of quartz sand with a particle size in a range of 40-70 meshes, 27%-30% of silicon micro-powders with a particle size in a range of 600-800 meshes, 0.02%-2.3% of colorant, 0.01%-0.015% of silane coupling agent, 10%-12% of UPR (unsaturated polyester resin) and 0.01%-0.014% of curing agent by weight.

Preferably, a mass percentage of the quartz sand with the particle size in the range of 26-40 meshes is able to be 17%, 18%, 19%, 20%, 21%, 22%, 23%, 24%, 25%, 26% and any value in the range of 17%-26%; a mass percentage of the quartz sand with the particle size in the range of 40-70 meshes is able to be 34%, 35%, 36%, 37%, 38%, 39%, 40%, 41% and any value in the range of 34%-41%; a mass percentage of the silicon micro-powders with the particle size in the range of 600-800 meshes is able to be 27%, 28%, 29%, 30% and any value in the range of 27%-30%; a mass percentage of the silane coupling agent is able to be 0.01%, 0.011%, 0.012%, 0.013%, 0.014%, 0.015% and any value in the range of 0.01%-0.015%; a mass percentage of the UPR is able to be 10%, 11%, 12% and any value in the range of 10% to 12%; and a mass percentage of the curing agent is able to be 0.01%, 0.011%, 0.012%, 0.013%, 0.014% and any value in the range of 0.01%-0.014%.

Preferably, a mass percentage of the material a, the material b and the material c in the material d is in a range of 50-60%, 25-35% and 5-15% respectively.

Preferably, the step (1) specifically comprises:
preparing the material a, which comprises adding quartz sand with a particle size in a range of 26-40 meshes and quartz sand with a particle size in a range of 40-70 meshes into a mixing tank, stirring evenly; adding UPR (unsaturated polyester resin), a colorant, a silane coupling agent and a curing agent into the mixing tank, stirring from slowly to fast for about 1 min; adding silicon micro-powders with a particle size in a range of 325-400 meshes, stirring from slowly to fast for about 1.5 min; and finally adding the pigment, stirring evenly to obtain the material a;
preparing the material b and the material c respectively, which comprises changing an amount of each ingredient, and repeating the above steps to obtain the material b and the material c; and obtaining the material d by evenly mixing the material a, the material b and the material c in a mixing system.

Preferably, the silane coupling agent is at least one member selected from a group consisting of KH550, KH560, KH570, KH792, DL602 and DL171.

Preferably, the curing agent is at least one member selected from a group consisting of tert-butyl peroxide, cyanamide, metaphenediamine and methylenediphenyldiamine.

Preferably, the UPR is at least one member selected from a group consisting of epoxy modified acrylic resin 7908A, alkyd resin and vinyl ester resin.

Preferably, a type of the colorant is selected according to actual needs.

Preferably, in the step (3), while performing the pattern treatment for a first time, the pigment paste comprises 100 G of resin, 0.03 G of lead chrome green and 0.018 G of Bayferrox black; in the step (3), while performing the pattern treatment for a second time, the pigment paste comprises 100 G of resin, 0.03 G of lead chrome green and 0.036 G of Bayferrox black; in the step (3), while performing the pattern treatment for a third time, the pigment paste comprises 100 G of resin, 0.05 G of Bayferrox black, 0.01 G of Bayferrox yellow and 1 G of titanium dioxide.

Preferably, in the step of (5), a baking temperature is in a range of 85° C. to 95° C., and a baking time is in a range of 40 min to 50 min.

Preferably, in the step of (5), the curing box comprises a box body and a plate layer, wherein the plate layer is provided within the box body and is made of aluminium alloy, the plate layer comprises seven upper plates and seven lower plates, the pressing plate is provided between the upper plates and the lower plates, a hot oil layer is provide within each of the upper and lower plates, an “S”-shaped hot oil pipe is provided within the hot oil layer, gasoline flows in the hot oil pipe to dry the pressing plate.

Preferably, in the step (2), a loading specification of the material distribution machine is 3t, a dosage of each 20 mm plate is 320 kg; the material distribution machine starts to material distribution according to a set weight; after the material distribution is finished, the material distribution machine automatically returns to a starting point and waits for a next mold; the distributed material is transported to a pressing machine through a conveyor belt, the pressing machine automatically starts to vacuumize, and perform vibration-assisted compaction when the pressing machine detects the plate, wherein the vibration-assisted compaction is performed at a frequency which varies according to an order of 39 Hz, 47 Hz, 52 Hz and 57 Hz for sheet forming, the formed plate is sent to the curing box to bake for 50 min at 85° C., and then is defined thickness and polished.

Preferably, in the step (3), there are three procedures which are performed by three robots respectively, wherein while performing the pattern treatment for a first time by a first robot, the pigment paste comprises 100 G of resin, 0.03 G of lead chrome green and 0.018 G of Bayferrox black, the three materials are mixed in the material barrel, the rocker arm and the spray head of the first robot are used to perform the pattern treatment; while performing the pattern treatment for a second time by a second robot, the pigment paste comprises 100 G of resin, 0.03 G of lead chrome green and 0.036 G of Bayferrox black; while performing the pattern treatment for a third time by a third robot, the pigment paste comprises 100 G of resin, 0.05 G of Bayferrox black, 0.01 G of Bayferrox yellow and 1 G of titanium dioxide. It should be noted that the patterns and the pigment pastes of the three robots are different from each other, but the working principles of the three robots are same. While the robots work, the trajectories of the spray heads of the robots are different from each other. The patterns have different sizes, so the material distribution areas of the robots are different from each other. The specific structure of each robot is able to refer to the patent document CN 112774909 A.

### First Embodiment

A preparation method of a quartz stone patterned full-body plate comprises steps of preparing a material, preparing a rough sheet, performing pattern treatment, preparing a pressing plate, baking, polishing and printing.

Preferably, the preparation method specifically comprises steps of:
(1) preparing a material d, which comprises preparing a material a, a material b and a material c respectively by mixing three different amounts of main materials with a pigment respectively, and stirring evenly; and mixing the material a, the material b and the material c, so as to obtain the material d;
(2) preparing a rough sheet e, which comprises transporting the material d from a blending machine to a material distribution machine, laying the material d evenly in a rubber membrane frame which is located under the material distribution machine, vacuumizing, vibration-assisted compacting, drying, thickness-defining, and polishing, so as to obtain the rough sheet e;
(3) performing pattern treatment, wherein the pattern treatment is performed on the rough sheet e for three times by a robot rocker arm;
(4) preparing a pressing plate by vacuumizing and vibration-assisted compacting, wherein a frequency of vacuumizing and vibration-assisted compacting is in a range of 39-57 Hz;
(5) baking, which comprises baking the pressing plate obtained by the step (4) in a curing box;
(6) polishing, wherein a polishing head is used to improve a smoothness of a sheet material obtained by the step (5), so that a surface smoothness of the sheet material is higher; and
(7) printing, which comprises simulating patterns of the quartz stone plate to be prepared in advance, wherein the patterns of the quartz stone plate to be prepared are consistent with patterns of a trajectory of the robot rocker arm in the step (3), processing the simulated patterns at high temperature in a printing machine, and printing the simulated patterns after high-temperature treatment on a quartz stone patterned plate obtained by the step (6).

Preferably, a mass percentage of all of the three main materials in the material d is 98.5%, a mass percentage of pigment paste is 1.0%, and a mass percentage of color powders is 0.5%.

Preferably, the pigment paste or the color powders in the material a comprises 2 parts of titanium dioxide, 0.5 part of Bayferrox black (Bayferrox iron oxide black), 0.2 part of Bayferrox yellow (Bayferrox iron oxide yellow) and 0.02 part of Bayferrox brown (Bayferrox iron oxide brown); the pigment paste or the color powders in the material b comprises 5 parts of titanium dioxide, 0.3 part of Bayferrox black, 0.03 part of Bayferrox yellow and 0.01 part of Bayferrox brown; the pigment paste or the color powders in the material c comprises 1 part of titanium dioxide, 0.05 part of Bayferrox black, and 0.005 part of Bayferrox yellow; and the use of the pigment paste or the color powders is able to be fine-tuned according to actual demands.

Preferably, each of the three main materials comprises 24.94% of quartz sand with a particle size in a range of 26-40 meshes, 36% of quartz sand with a particle size in a range of 40-70 meshes, 28% of silicon micro-powders with a particle size in a range of 600-800 meshes, 0.035% of colorant, 0.013% of silane coupling agent, 11% of UPR (unsaturated polyester resin) and 0.012% of curing agent by weight.

Preferably, a mass percentage of the material a, the material b and the material c in the material d is 55%, 35% and 10% respectively.

Preferably, the step (1) specifically comprises:
preparing the material a, which comprises adding quartz sand with a particle size in a range of 26-40 meshes and quartz sand with a particle size in a range of 40-70 meshes into a mixing tank, stirring evenly; adding UPR (unsaturated polyester resin), a colorant, a silane coupling agent and a curing agent into the mixing tank, stirring from slowly to fast for about 1 min; adding silicon micro-powders with a particle size in a range of 325-400 meshes, stirring from slowly to fast for about 1.5 min; and finally adding the pigment, stirring evenly to obtain the material a;
preparing the material b and the material c respectively, which comprises changing an amount of each ingredient, and repeating the above steps to obtain the material b and the material c; and obtaining the material d by evenly mixing the material a, the material b and the material c in a mixing system.

Preferably, the silane coupling agent is KH560.

Preferably, the curing agent is tert-butyl peroxide.

Preferably, the UPR is epoxy modified acrylic resin 7908A.

Preferably, a type of the colorant is selected according to actual needs.

Preferably, in the step (3), while performing the pattern treatment for a first time, the pigment paste comprises 100 G of resin, 0.03 G of lead chrome green and 0.018 G of Bayferrox black; in the step (3), while performing the pattern treatment for a second time, the pigment paste comprises 100 G of resin, 0.03 G of lead chrome green and 0.036 G of Bayferrox black; in the step (3), while performing the pattern treatment for a third time, the pigment paste comprises 100 G of resin, 0.05 G of Bayferrox black, 0.01 G of Bayferrox yellow and 1 G of titanium dioxide.

Preferably, in the step of (5), a baking temperature is 85° C., and a baking time is 50 min.

Preferably, in the step of (5), the curing box comprises a box body and a plate layer, wherein the plate layer is provided within the box body and is made of aluminium alloy, the plate layer comprises seven upper plates and seven lower plates, the pressing plate is provided between the upper plates and the lower plates, a hot oil layer is provide within each of the upper and lower plates, an “S”-shaped hot oil pipe is provided within the hot oil layer, gasoline flows in the hot oil pipe to dry the pressing plate.

### Second Embodiment

A preparation method of a quartz stone patterned full-body plate comprises steps of preparing a material, preparing a rough sheet, performing pattern treatment, preparing a pressing plate, baking, polishing and printing.

Preferably, the preparation method specifically comprises steps of:
(1) preparing a material d, which comprises preparing a material a, a material b and a material c respectively by mixing three different amounts of main materials with a pigment respectively, and stirring evenly; and mixing the material a, the material b and the material c, so as to obtain the material d;
(2) preparing a rough sheet e, which comprises transporting the material d from a blending machine to a material distribution machine, laying the material d evenly in a rubber membrane frame which is located under the material distribution machine, vacuumizing, vibration-assisted compacting, drying, thickness-defining, and polishing, so as to obtain the rough sheet e;
(3) performing pattern treatment, wherein the pattern treatment is performed on the rough sheet e for three times by a robot rocker arm;
(4) preparing a pressing plate by vacuumizing and vibration-assisted compacting, wherein a frequency of vacuumizing and vibration-assisted compacting is in a range of 39-57 Hz;
(5) baking, which comprises baking the pressing plate obtained by the step (4) in a curing box;
(6) polishing, wherein a polishing head is used to improve a smoothness of a sheet material obtained by the step (5), so that a surface smoothness of the sheet material is higher; and
(7) printing, which comprises simulating patterns of the quartz stone plate to be prepared in advance, wherein the patterns of the quartz stone plate to be prepared are consistent with patterns of a trajectory of the robot rocker arm in the step (3), processing the simulated patterns at high temperature in a printing machine, and printing the simulated patterns after high-temperature treatment on a quartz stone patterned plate obtained by the step (6).

Preferably, a mass percentage of all of the three main materials in the material d is 98.7%, a mass percentage of pigment paste is 0.8%, and a mass percentage of color powders is 0.5%.

Preferably, the pigment paste or the color powders in the material a comprises 2 parts of titanium dioxide, 0.5 part of Bayferrox black (Bayferrox iron oxide black), 0.2 part of Bayferrox yellow (Bayferrox iron oxide yellow) and 0.02 part of Bayferrox brown (Bayferrox iron oxide brown); the pigment paste or the color powders in the material b comprises 5 parts of titanium dioxide, 0.3 part of Bayferrox black, 0.03 part of Bayferrox yellow and 0.01 part of Bayferrox brown; the pigment paste or the color powders in the material c comprises 1 part of titanium dioxide, 0.05 part of Bayferrox black, and 0.005 part of Bayferrox yellow; and the use of the pigment paste or the color powders is able to be fine-tuned according to actual demands.

Preferably, each of the three main materials comprises 25.56% of quartz sand with a particle size in a range of 26-40 meshes, 34.912% of quartz sand with a particle size in a range of 40-70 meshes, 28.5% of silicon micro-powders with a particle size in a range of 600-800 meshes, 0.055% of colorant, 0.013% of silane coupling agent, 10.95% of UPR (unsaturated polyester resin) and 0.01% of curing agent by weight.

Preferably, a mass percentage of the material a, the material b and the material c in the material d is 60%, 30% and 10% respectively.

Preferably, the step (1) specifically comprises:
preparing the material a, which comprises adding quartz sand with a particle size in a range of 26-40 meshes and quartz sand with a particle size in a range of 40-70 meshes into a mixing tank, stirring evenly; adding UPR (unsaturated polyester resin), a colorant, a silane coupling agent and a curing agent into the mixing tank, stirring from slowly to fast for about 1 min; adding silicon micro-powders with a particle size in a range of 325-400 meshes, stirring from slowly to fast for about 1.5 min; and finally adding the pigment, stirring evenly to obtain the material a;
preparing the material b and the material c respectively, which comprises changing an amount of each ingredient, and repeating the above steps to obtain the material b and the material c; and
obtaining the material d by evenly mixing the material a, the material b and the material c in a mixing system.

Preferably, the silane coupling agent is KH570.

Preferably, the curing agent is metaphenediamine.

Preferably, the UPR is vinyl ester resin.

Preferably, a type of the colorant is selected according to actual needs.

Preferably, in the step (3), while performing the pattern treatment for a first time, the pigment paste comprises 100 G of resin, 0.03 G of lead chrome green and 0.018 G of Bayferrox black; in the step (3), while performing the pattern treatment for a second time, the pigment paste comprises 100 G of resin, 0.03 G of lead chrome green and 0.036 G of Bayferrox black; in the step (3), while performing the pattern treatment for a third time, the pigment paste comprises 100 G of resin, 0.05 G of Bayferrox black, 0.01 G of Bayferrox yellow and 1 G of titanium dioxide.

Preferably, in the step of (5), a baking temperature is 90° C., and a baking time is 45 min.

Preferably, in the step of (5), the curing box comprises a box body and a plate layer, wherein the plate layer is provided within the box body and is made of aluminium alloy, the plate layer comprises seven upper plates and seven lower plates, the pressing plate is provided between the upper plates and the lower plates, a hot oil layer is provide within each of the upper and lower plates, an “S”-shaped hot oil pipe is provided within the hot oil layer, gasoline flows in the hot oil pipe to dry the pressing plate.

### Third Embodiment

A preparation method of a quartz stone patterned full-body plate comprises steps of preparing a material, preparing a rough sheet, performing pattern treatment, preparing a pressing plate, baking, polishing and printing.

Preferably, the preparation method specifically comprises steps of:
(1) preparing a material d, which comprises preparing a material a, a material b and a material c respectively by mixing three different amounts of main materials with a pigment respectively, and stirring evenly; and mixing the material a, the material b and the material c, so as to obtain the material d;
(2) preparing a rough sheet e, which comprises transporting the material d from a blending machine to a material distribution machine, laying the material d evenly in a rubber membrane frame which is located under the material distribution machine, vacuumizing, vibration-assisted compacting, drying, thickness-defining, and polishing, so as to obtain the rough sheet e;
(3) performing pattern treatment, wherein the pattern treatment is performed on the rough sheet e for three times by a robot rocker arm;
(4) preparing a pressing plate by vacuumizing and vibration-assisted compacting, wherein a frequency of vacuumizing and vibration-assisted compacting is in a range of 39-57 Hz;
(5) baking, which comprises baking the pressing plate obtained by the step (4) in a curing box;
(6) polishing, wherein a polishing head is used to improve a smoothness of a sheet material obtained by the step (5), so that a surface smoothness of the sheet material is higher; and
(7) printing, which comprises simulating patterns of the quartz stone plate to be prepared in advance, wherein the patterns of the quartz stone plate to be prepared are consistent with patterns of a trajectory of the robot rocker arm in the step (3), processing the simulated patterns at high temperature in a printing machine, and printing the simulated patterns after high-temperature treatment on a quartz stone patterned plate obtained by the step (6).

Preferably, a mass percentage of all of the three main materials in the material d is 90.0%, a mass percentage of pigment paste is 1.2%, and a mass percentage of color powders is 0.8%.

Preferably, the pigment paste or the color powders in the material a comprises 2 parts of titanium dioxide, 0.5 part of Bayferrox black (Bayferrox iron oxide black), 0.2 part of Bayferrox yellow (Bayferrox iron oxide yellow) and 0.02 part of Bayferrox brown (Bayferrox iron oxide brown); the pigment paste or the color powders in the material b comprises 5 parts of titanium dioxide, 0.3 part of Bayferrox black, 0.03 part of Bayferrox yellow and 0.01 part of Bayferrox brown; the pigment paste or the color powders in the material c comprises 1 part of titanium dioxide, 0.05 part of Bayferrox black, and 0.005 part of Bayferrox yellow; and the use of the pigment paste or the color powders is able to be fine-tuned according to actual demands.

Preferably, each of the three main materials comprises 25.6% of quartz sand with a particle size in a range of 26-40 meshes, 35.3% of quartz sand with a particle size in a range of 40-70 meshes, 27.9% of silicon micro-powders with a particle size in a range of 600-800 meshes, 0.073% of colorant, 0.015% of silane coupling agent, 11.1% of UPR (unsaturated polyester resin) and 0.012% of curing agent by weight.

Preferably, a mass percentage of the material a, the material b and the material c in the material d is 52%, 34% and 12% respectively.

Preferably, the step (1) specifically comprises:
preparing the material a, which comprises adding quartz sand with a particle size in a range of 26-40 meshes and quartz sand with a particle size in a range of 40-70 meshes into a mixing tank, stirring evenly; adding UPR (unsaturated polyester resin), a colorant, a silane coupling agent and a curing agent into the mixing tank, stirring from slowly to fast for about 1 min; adding silicon micro-powders with a particle size in a range of 325-400 meshes, stirring from slowly to fast for about 1.5 min; and finally adding the pigment, stirring evenly to obtain the material a;
preparing the material b and the material c respectively, which comprises changing an amount of each ingredient, and repeating the above steps to obtain the material b and the material c; and
obtaining the material d by evenly mixing the material a, the material b and the material c in a mixing system.

Preferably, the silane coupling agent is KH792.

Preferably, the curing agent is cyanamide.

Preferably, the UPR is vinyl ester resin.

Preferably, a type of the colorant is selected according to actual needs.

Preferably, in the step (3), while performing the pattern treatment for a first time, the pigment paste comprises 100 G of resin, 0.03 G of lead chrome green and 0.018 G of Bayferrox black; in the step (3), while performing the pattern treatment for a second time, the pigment paste comprises 100 G of resin, 0.03 G of lead chrome green and 0.036 G of Bayferrox black; in the step (3), while performing the pattern treatment for a third time, the pigment paste comprises 100 G of resin, 0.05 G of Bayferrox black, 0.01 G of Bayferrox yellow and 1 G of titanium dioxide.

Preferably, in the step of (5), a baking temperature is 90° C., and a baking time is 45 min.

Preferably, in the step of (5), the curing box comprises a box body and a plate layer, wherein the plate layer is provided within the box body and is made of aluminium alloy, the plate layer comprises seven upper plates and seven lower plates, the pressing plate is provided between the upper plates and the lower plates, a hot oil layer is provide within each of the upper and lower plates, an “S”-shaped hot oil pipe is provided within the hot oil layer, gasoline flows in the hot oil pipe to dry the pressing plate.

The properties of the quartz stone patterned full-body plates prepared by the methods according to the first, second and third embodiments are tested. Specifically, the bending strength of the quartz stone patterned full-body plates is tested with reference to ASTMC880/C880M-15; the abrasion resistance of the quartz stone patterned full-body plates is tested with reference to ASTM C241; the impact resistance of the quartz stone patterned full-body plates is tested with reference to EN14617-9:2005; the antifouling property is tested with reference to ANSI Z124.6-2007; the water absorption and the bulk specific gravity are tested with reference to ASTMC97/C97M-18. The test results are shown in Table 1.

TABLE 1
Test Results of properties of the quartz
stone patterned full-body plates

| | First | Second | Third |
|---|---|---|---|
| | Embodiment | Embodiment | Embodiment |
| Compressive Strength | 244.8 | 244.1 | 240.9 |
| (Dry Condition), MPa | | | |
| Compressive Strength | 221.5 | 220.1 | 220.8 |
| (Wet Condition), MPa | | | |
| Bending Strength | 66.1 | 65.9 | 65.2 |
| (Dry Condition), MPa | | | |
| Bending Strength | 67.5 | 66.2 | 66.8 |
| (Wet Condition), MPa | | | |
| Abrasion Resistance | 25.4 | 26.3 | 27.1 |
| Work of Fracture (J) | >22.65 | >22.65 | >22.65 |
| Antifouling Property | 52 | 53 | 52 |
| Water Absorption (%) | 0.01 | 0.02 | 0.01 |
| Bulk Specific Gravity | 2.27 | 2.24 | 2.28 |

It is able to be seen that the prepared quartz stone patterned full-body plates have excellent performances.

The above embodiments are only intended to illustrate the technical conception and characteristics of the present invention, and are intended to enable those skilled in the art to understand the content of the present invention and implement the present invention accordingly. Therefore, the above embodiments are unable to limit the protection scope of the present invention. Any equivalent variation or modification made in accordance with the spirit of the present invention shall be covered by the protection scope of the present invention.

1. A preparation method of a quartz stone patterned full-body plate, the preparation method comprising seven steps of preparing a material, preparing a rough sheet, performing pattern treatment, preparing a pressing plate, baking, polishing and printing.

2. The preparation method of the quartz stone patterned full-body plate according to claim 1, wherein the preparation method specifically comprises steps of:
(1) preparing a material d, which comprises preparing a material a, a material b and a material c respectively by mixing three different amounts of main materials with a pigment respectively, and stirring evenly; and mixing the material a, the material b and the material c, so as to obtain the material d;
(2) preparing a rough sheet e, which comprises transporting the material d from a blending machine to a material distribution machine, laying the material d evenly in a rubber membrane frame which is located under the material distribution machine, vacuumizing, vibration-assisted compacting, drying, thickness-defining, and polishing, so as to obtain the rough sheet e;
(3) performing pattern treatment, wherein the pattern treatment is performed on the rough sheet e for three times by a robot rocker arm;
(4) preparing a pressing plate by vacuumizing and vibration-assisted compacting, wherein a frequency of vacuumizing and vibration-assisted compacting is in a range of 39-57 Hz;
(5) baking, which comprises baking the pressing plate obtained by the step (4) in a curing box;
(6) polishing, wherein a polishing head is used to improve a smoothness of a sheet material obtained by the step (5), so that a surface smoothness of the sheet material is higher; and
(7) printing, which comprises simulating patterns of the quartz stone plate to be prepared in advance, wherein the patterns of the quartz stone plate to be prepared are consistent with patterns of a trajectory of the robot rocker arm in the step (3), processing the simulated patterns at high temperature in a printing machine, and printing the simulated patterns after high-temperature treatment on a quartz stone patterned plate obtained by the step (6).

3. The preparation method of the quartz stone patterned full-body plate according to claim 2, wherein a mass percentage of all of the three main materials in the material d is in a range of 97.5% to 99.85%, the rest is the pigment; a mass percentage of pigment paste and color powders of the pigment in the material d is in a range of 0.1%-1.5% and 0.05%-1% respectively.

4. The preparation method of the quartz stone patterned full-body plate according to claim 2, wherein each of the three main materials comprises 17%-26% of quartz sand with a particle size in a range of 26-40 meshes, 34%-41% of quartz sand with a particle size in a range of 40-70 meshes, 27%-30% of silicon micro-powders with a particle size in a range of 600-800 meshes, 0.02%-2.3% of colorant, 0.01%-0.015% of silane coupling agent, 10%-12% of UPR (unsaturated polyester resin) and 0.01%-0.014% of curing agent by weight.

5. The preparation method of the quartz stone patterned full-body plate according to claim 2, wherein a mass percentage of the material a, the material b and the material c in the material d is in a range of 50-60%, 25-35% and 5-15% respectively.

6. The preparation method of the quartz stone patterned full-body plate according to claim 4, wherein the silane coupling agent is at least one member selected from a group consisting of KH550, KH560, KH570, KH792, DL602 and DL171; the curing agent is at least one member selected from a group consisting of tert-butyl peroxide, cyanamide, metaphenediamine and methylenediphenyldiamine.

7. The preparation method of the quartz stone patterned full-body plate according to claim 1, wherein in the step (3), while performing the pattern treatment for a first time, the pigment paste comprises 100 G of resin, 0.03 G of lead chrome green and 0.018 G of Bayferrox black; in the step (3), while performing the pattern treatment for a second time, the pigment paste comprises 100 G of resin, 0.03 G of lead chrome green and 0.036 G of Bayferrox black; in the step (3), while performing the pattern treatment for a third time, the pigment paste comprises 100 G of resin, 0.05 G of Bayferrox black, 0.01 G of Bayferrox yellow and 1 G of titanium dioxide.

8. The preparation method of the quartz stone patterned full-body plate according to claim 1, wherein in the step of (5), a baking temperature is in a range of 85° C. to 95° C., and a baking time is in a range of 40 min to 50 min.

9. The preparation method of the quartz stone patterned full-body plate according to claim 8, wherein in the step of (5), the curing box comprises a box body and a plate layer, wherein the plate layer is provided within the box body and is made of aluminium alloy, the plate layer comprises seven upper plates and seven lower plates, the pressing plate is provided between the upper plates and the lower plates, a hot oil layer is provide within each of the upper and lower plates, an “S”-shaped hot oil pipe is provided within the hot oil layer, gasoline flows in the hot oil pipe to dry the pressing plate.

10. A quartz stone patterned full-body plate prepared by the preparation method according to claim 2.
